(19) United States
(12) Patent Application Publication
(10) Pub. No.: US 2024/0204659 A1
(43) Pub. Date: Jun. 20, 2024

(54) HIGH EFFICIENCY POWER CONVERTER

(71) Applicant: Apple Inc., Cupertino, CA (US)

(72) Inventors: Francesco Maria Dalena, Livorno (IT); Simone Silvestri, Livorno (IT)

(21) Appl. No.: 18/068,366

(22) Filed: Dec. 19, 2022

(51) Int. Cl. H02M 3/07; H02J 7/00; H02M 1/00; H02M 3/158

(52) U.S. Cl. CPC H02M 3/07; H02J 7/007; H02M 1/0058; H02M 3/158; H02J 2207/20

(57) ABSTRACT

A high efficiency battery charger can include a resonant switched capacitor converter that receives an input voltage and input current from a power source and produces an intermediate voltage that is a fraction of the input voltage and an intermediate current that is a corresponding multiple of the input current and a buck regulator that receives the intermediate voltage and the intermediate current and produces an output battery charging voltage and an output battery charging current, wherein the output voltage is less than the intermediate voltage. The resonant switched capacitor converter can include one or more resonant switched capacitor stages.

### BACKGROUND

Increased usage of mobile electronic devices places significant power demand on the batteries of such devices. Longer battery runtime requires larger batteries, which, in some cases may be cost prohibitive or adversely impact size and weight of the device. As a result, battery charging cycles occur more frequently. In many cases, users may prefer that the battery charge as quickly as possible to be able resume “normal” device usage (i.e., usage without being connected to a wired or wireless power source for charging) as soon as possible. Advancements in battery chemistry have allowed for higher battery charging rates, but in at least some instances, thermal and efficiency constraints of the charger circuitry may become the factor that limits battery charging rates.

### SUMMARY

Thus, it may be desirable to provide battery charging circuits for electronic devices that have improved efficiency to allow for higher battery charging rates. Such battery charging circuits can be based on power converters that can be used in a variety of other applications.

A high efficiency power converter, which can be used as a battery charger or in other applications, can include a resonant switched capacitor converter that receives an input voltage and input current from a power source and produces an intermediate voltage that is a fraction of the input voltage and an intermediate current that is a corresponding multiple of the input current and a buck regulator that receives the intermediate voltage and the intermediate current and produces an output battery charging voltage and an output battery charging current, wherein the output voltage is less than the intermediate voltage. The resonant switched capacitor converter can include one or more resonant switched capacitor stages.

The one or more resonant switched capacitor stages can each include a ladder of four switching devices coupled across an input of the switched capacitor stage, a resonant tank circuit including a flying capacitor and a resonant inductance coupled between a junction of a first and a second switching device of the ladder and a junction of a third and fourth switching device of the ladder, and an output terminal located at a junction of the second and third switching devices of the ladder. The resonant tank circuit can be a series resonant circuit. The resonant inductance can include a discrete inductance. The resonant inductance can include one or more parasitic inductances.

The high efficiency power converter, which can be used as a battery charger, can further include controller circuitry that regulates a switching frequency of the resonant switched capacitor converter to achieve soft switching. The controller circuitry can regulate the switching frequency of the resonant switched capacitor converter to achieve soft switching responsive to a phase of a flying capacitor voltage of the switched capacitor converter relative to mode transitions of the switched capacitor converter. The controller circuitry can also control switching of the buck regulator to produce the output battery charging voltage and output battery charging current responsive to a battery charging profile control loop. A switching frequency of the buck regulator can be independent of a switching frequency of the resonant switched capacitor converter.

A power converter can include a resonant switched capacitor converter having one or more resonant switched capacitor stages, each resonant switched capacitor stage further including a ladder of four switching devices coupled across an input of the switched capacitor stage, a resonant tank circuit including a flying capacitor and a resonant inductance coupled between a junction of a first and a second switching device of the ladder and a junction of a third and fourth switching device of the ladder, and an output terminal located at a junction of the second and third switching devices of the ladder. The resonant switched capacitor converter can receive an input voltage and input current from a power source and can produce an intermediate voltage that is a fraction of the input voltage and an intermediate current that is a corresponding multiple of the input current. The power converter can further include a buck regulator that receives the intermediate voltage and the intermediate current and produces an output voltage and an output current, wherein the output voltage is less than the intermediate voltage. The power converter can further include controller circuitry that regulates a switching frequency of the resonant switched capacitor converter to achieve soft switching. The resonant tank circuit can be a series resonant circuit. The resonant inductance can include a discrete inductance. The resonant inductance can include one or more parasitic inductances. The controller circuitry can regulate the switching frequency of the resonant switched capacitor converter to achieve soft switching responsive to a phase of a flying capacitor voltage of the switched capacitor converter relative to mode transitions of the switched capacitor converter.

A resonant switched capacitor converter can include one or more resonant switched capacitor stages, each resonant switched capacitor stage including a ladder of four switching devices coupled across an input of the switched capacitor stage, a resonant tank circuit including a flying capacitor and a resonant inductance coupled between a junction of a first and a second switching device of the ladder and a junction of a third and fourth switching device of the ladder, an output terminal located at a junction of the second and third switching devices of the ladder, and controller circuitry that regulates a switching frequency of the resonant switched capacitor converter to achieve soft switching. The resonant tank circuit can be a series resonant circuit. The resonant inductance can include a discrete inductance. The resonant inductance can include one or more parasitic inductances. The controller circuitry can regulate the switching frequency of the resonant switched capacitor converter to achieve soft switching responsive to a phase of a flying capacitor voltage of the switched capacitor converter relative to mode transitions of the switched capacitor converter.

### BRIEF DESCRIPTION OF THE DRAWINGS

FIG. 1 illustrates a block diagram of a battery charger system incorporating a switched capacitor converter.

FIG. 2 illustrates a schematic of a switched capacitor converter.

FIG. 3 illustrates switching losses associated with a battery charger system.

FIG. 4 illustrates a resonant switched capacitor converter.

FIG. 5 illustrates various waveforms of a resonant switched capacitor converter.

FIG. 6 illustrates a block diagram of a battery charger system incorporating a resonant switched capacitor converter.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

As noted above, users of electronic devices may prefer that the batteries of such devices charge as quickly as possible. Faster battery charging requires higher charging current to be delivered to the battery. This correspondingly results in higher power requirements from the power source used for battery charging. In some cases, limits relating to the efficiency of the battery charging circuitry may be the factor that limits charging rate. Efficiency of the battery charging circuitry can be improved by increasing the input voltage into the charging circuitry, which can allow for the same (higher) power level to be delivered with a lower current. Nonetheless, this input power must ultimately be converted into a higher current for the battery.

Because power is the product of voltage and current, increasing the current can correspond to a reduction in voltage while delivering the same power level. One efficient converter type for achieving this result is a Switched Capacitor Converter, also sometimes known as “Switched Capacitor Voltage Dividers,” “SwCap Converters,” or “Flying Capacitor Converters.” Such circuits are in some respects similar to a transformer in operation, in that they can step down the voltage by an integer multiple while stepping up the current by the same integer multiple (or vice versa). As a result, the current injected into the battery can be multiplied from the input current supplied to the device by the adapter. This increased current can allow for higher battery charging rates.

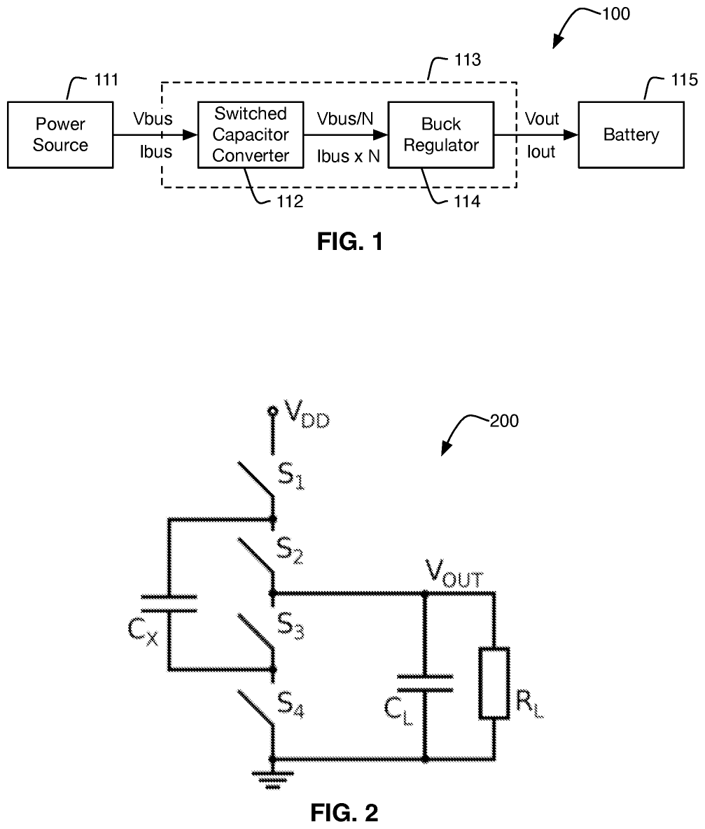

FIG. 1 illustrates a block diagram of a battery charger system 100 incorporating a switched capacitor converter. Power is received from a power source 111. Power source 111 can be any of a variety of wired or wireless power sources, including, without limitation, an AC-DC converter/adapter connected to mains power; a wireless power delivery system, such as a Qi wireless power transfer system or other inductive or capacitive wireless power transfer system; a DC power source such as a battery pack, etc. For purposes of discussion herein, power source 111 will be considered to deliver DC power at a voltage Vbus and a current Ibus. The resulting power is the product of these values.

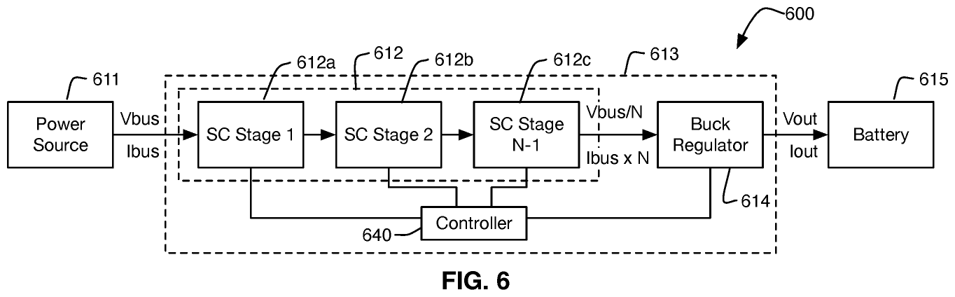

Power from power source 111 can be delivered to charging circuitry 113. In some cases charging circuitry 113 can be part of an electronic device containing a battery 115. As non-limiting examples, such electronic devices could include laptop or notebook computers, tablet computers, smartphones, smart watches, and/or their associated accessories. However, charging circuitry need not necessarily be part of such an electronic device or accessory. Charging circuitry 113 could alternatively be implemented as part of an adapter or other power source for charging a battery containing electronic device. In any case, charging circuitry 113 can include a switched capacitor converter 112 that receives input power (Vbus×Ibus) and delivers it at a reduced voltage (Vbus/N) and increased current (Ibus×N) to a buck regulator 114. The number N may be an integer fraction/multiple applied to the input voltage and current, as described in greater detail below with respect to FIG. 6. In general, a single switched capacitor stage can provide a 2:1 conversion ratio, a two-stage switched capacitor stage can provide either a 2:1 or 3:1 ratio, etc. Stated more generally, “N−1” switched capacitor stages can provide a conversion ratio between N:1 and 1:1.

The foregoing discussion neglects the operating efficiency of switched capacitor converter; however, such efficiency can be in the high 90s, e.g., 97-98% or greater, thus the basic description above holds.

In any case, the reduced voltage/increased current from switched capacitor converter 112 can be delivered to buck regulator 114. Buck regulator 114 can produce an output voltage Vout and output current Iout regulated by a battery charging control loop to be appropriate for battery charging. This output can then be delivered to battery 115. As noted above, to achieve higher charging rates, it may be desirable for this current to be relatively high during at least the initial portion of the battery charging cycle. The net power input into the buck regulator (approximately Vbus/N×Ibus×N or Vbus×Ibus) will be approximately equal to its output power (Vout×Iout). The efficiency of a buck regulator/converter is directly related to the voltage conversion ratio it provides. Thus, buck regulator will achieve maximum efficiency when its input voltage Vbus/N is close to its output voltage Vout. For example, a buck converter operating at a fairly close voltage conversion ratio (i.e., where Vbus/N is very close to Vout) can have an efficiency in the mid-to-high 90s, e.g., 95% to 97%. Thus, the overall efficiency of battery charging circuitry 113 is the product of the switched capacitor converter efficiency (e.g., 97-98%) and the buck regulator efficiency (e.g., 95-97%). The resulting combined efficiency (e.g., 92-95%) can be much higher than the efficiency of a single buck regulator stage that converted Vbus/Ibus to Vout/Iout directly.

Further aspects of battery charging circuits incorporating switched capacitor converters are described in one of the present inventor's issued U.S. Pat. No. 11,387,666, which is hereby incorporated by reference in its entirety.

FIG. 2 illustrates a schematic of a switched capacitor converter 200. More specifically, switched capacitor converter 200 is a single stage switched capacitor converter. Switched capacitor converter includes a flying capacitor Cx and a ladder of switching devices S1-S4. The input voltage Vdd can be connected across the ladder (i.e., across the upper terminal of switch S1 and the lower terminal of switch S4). The output can be taken from the midpoint of the ladder, i.e., the junction between switches S2 and S3. The flying capacitor can be coupled between the junction point of switches S1 and S2 and the junction point of switches S3 and S4. Switching devices S1-S4 may be any suitable switching device, such as transistors, SCRs, thyristors, etc. For many applications, metal oxide semiconductor field effect transistors (MOSFETs) can be used. Such MOSFETs can be based on silicon (Si), silicon carbide (SiC), gallium nitride (GaN) or other semiconductor technology selected as appropriate for the application.

Basic operation of switched capacitor converter 200 is as follows. The switched capacitor converter can operate between a first state, in which the flying capacitor Cx is connected in parallel with the load (RL) and the input (VDD), and a second state, in which the flying capacitor is connected in series with the Load (RL) and the input (VDD). The first state can be achieved by closing switches S1, S2, and S4, which produces the parallel current path described above. In this first state, the input delivers power to the load RL and also charges (i.e., stores energy in) the flying capacitor Cx. The second state can be achieved by closing switches S1 and S3 while leaving switches S2 and S4 open, which produces the serial current path described above. During this second state, the input continues to deliver power to the load RL while the flying capacitor Cx also discharges, delivering additional power to the load. Output capacitor CL can serve as a filter capacitor that can stabilize the output voltage.

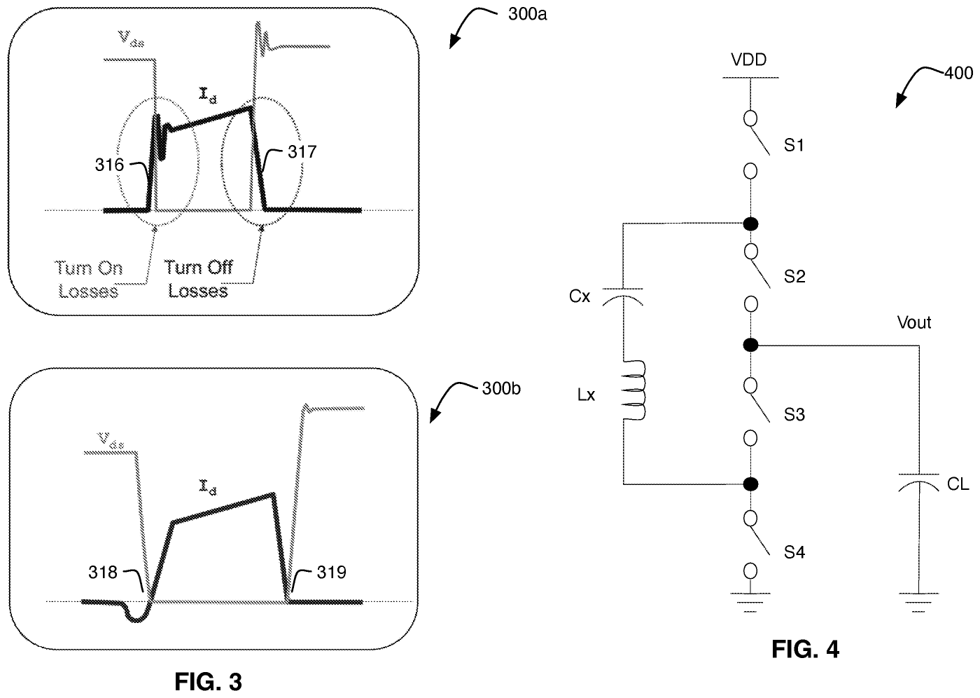

FIG. 3 illustrates switching losses associated with a battery charger system. More specifically, plot 300a illustrates switching losses associated with a switching device, such as switching devices S1-S4 of the above-described switched capacitor converter. Curve Vds shows the drain to source voltage of the switching device, which is initially high (when the switch is turned off), drops to zero when the switch is turned on and increases back to a high value when the switch is turned off again. Curve Id shows the drain current flowing through the transistor, which starts at zero when the switch is off, increases rapidly when the switch is turned on, continues increasing more slowly during the time that the switch is on, and decreases rapidly when the switch is turned off. Switching losses in the switching device are the product of the voltage Vds and current Id. Thus, the triangular area 316 under these two curves represents the turn on losses associated with turning on the switching device. The triangular area 317 under these two curves represents the turn off losses associated with turning off the switching device. Efficiency of the system can be improved if these areas can be reduced or eliminated. Such a configuration is known as “soft switching” and can include zero voltage switching (ZVS) and/or zero current switching (ZCS).

Plot 300b illustrates the elimination of switching losses described above. As before, curve Vds shows the drain to source voltage of the switching device, which is initially high (when the switch is turned off), drops to zero when the switch is turned on and increases back to a high value when the switch is turned off again. Curve Id shows the drain current flowing through the transistor, which starts at zero when the switch is off, increases rapidly when the switch is turned on, continues increasing more slowly during the time that the switch is on, and decreases rapidly when the switch is turned off. In the example of plot 300b, the voltage transitions from high to low and low to high are slowed, as indicated by the finite slope of the voltage waveform, as opposed to the vertical (infinite) slope in plot 300a. Also, the current Id experiences a brief reversal/dip just before 318 when the switch is closed. Finally, current Id ramps down to zero just before 319, when the switch is turned off. These modifications of the voltage and current associated with the switching devices can be achieved by modifying the switched capacitor converter to have a partially resonant operation, as discussed below with respect to FIG. 4.

FIG. 4 illustrates a resonant switched capacitor converter 400 that has been modified to have a partially resonant operation. The construction of switched capacitor converter 400 is as described above with respect to switched capacitor converter 200 of FIG. 2, with the addition of a resonant inductance Lx in series with the flying capacitor Cx. Resonant inductance Lx may include one or more discrete inductors. Alternatively, resonant inductance may include only parasitic inductances associated with device packaging, printed circuit board layout (or other circuit layout), etc. In some embodiments, the resonant inductance could include both discrete and parasitic inductances. In any of the cases employing parasitic inductance to achieve the desired resonant operation, the circuitry could be specially designed or selected to achieve a desired level of inductance, for example by purposeful routing of PCB traces to achieve a target inductance, etc.

Operation of the switched capacitor converter 400 of FIG. 4 is broadly as described above with respect to switched capacitor 200 of FIG. 2, in that the converter alternates between a “parallel” state in which the resonant tank made up of flying capacitor Cx and resonant inductance Lx is in parallel with the input (input voltage Vdd) and output (output voltage Vout) and a “series” state in which the resonant tank is coupled in series between the input and output. However, timing of the switching events (i.e., the switching frequency) may be controlled to allow for the resonant operation of the resonant tank to achieve soft switching for the various switching elements. Any of a variety of control strategies may be implemented by the controller circuitry (discussed below with respect to FIG. 6) to achieve the desired switching frequency.

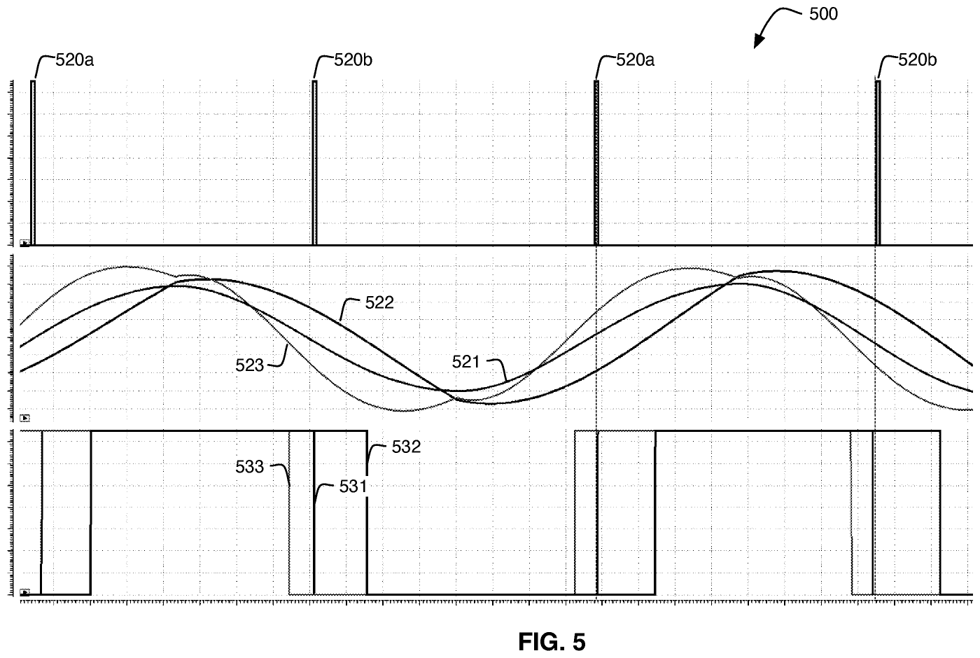

FIG. 5 illustrates a plot 500 of various waveforms of a resonant switched capacitor converter 400 of FIG. 4. More specifically, clock pulses 520a indicate the triggering of the “parallel” mode described above in which the resonant tank circuit is connected in parallel with the input and output, thereby charging flying capacitor Cx. Clock pulses 520b indicate triggering of the “series” mode described above in which the resonant tank circuit is connected in series between the input and output, thereby discharging flying capacitor Cx. Waveform 521 depicts the flying capacitor voltage for the nominal case in which the switching frequency of switching devices matches the resonant frequency of the resonant tank including flying capacitor Cx and resonant inductance Lx. Square wave trace 531 represents a corresponding current reversal signal for the flying capacitor. This signal is high when the flying capacitor is charging and low when the flying capacitor is discharging. When the switching frequency of the switched capacitor converter matches the resonant frequency of the resonant tank circuit, the flying capacitor current zero crossings are in phase and synchronized with the mode transitions of the converter.

Conversely, waveform 522 depicts the flying capacitor voltage for the case in which the switching frequency of switching devices is higher than the resonant frequency of the resonant tank. Square wave trace 532 represents the corresponding zero crossing signal. As can be seen, when the switching frequency is higher than the resonant frequency of the tank circuit, the flying capacitor voltage (and associated current reversal) lags the mode transition. Similarly, waveform 523 depicts the flying capacitor voltage for the case in which the switching frequency of switching devices is lower than the resonant frequency of the resonant tank. Square wave trace 533 represents the corresponding zero crossing signal. As can be seen, the flying capacitor voltage (and associated zero crossing) leads the mode transition in this case. Thus, in some embodiments, the phase angle of the flying capacitor voltage and/or the timing of the resonant tank current reversal can be used as a feedback parameter for the controller to adjust the switching frequency of the flying capacitor converter to achieve soft switching via resonant operation of the resonant tank circuit.

FIG. 6 illustrates a block diagram of a battery charger system incorporating one or more resonant switched capacitor converters as described above with respect to FIGS. 4-5. Power is received from a power source 611. Power source 611 can be any of a variety of wired or wireless power sources, including, without limitation, an AC-DC converter/adapter connected to mains power; a wireless power delivery system, such as a Qi wireless power transfer system or other inductive or capacitive wireless power transfer system; a DC power source such as a battery pack, etc. For purposes of discussion herein, power source 611 will be considered to deliver DC power at a voltage Vbus and a current Ibus. The resulting power is the product of these values.

Power from power source 611 can be delivered to charging circuitry 613. In some cases charging circuitry 613 can be part of an electronic device containing a battery 615. As non-limiting examples, such electronic devices could include laptop or notebook computers, tablet computers, smartphones, smart watches, and/or their associated accessories. However, charging circuitry need not necessarily be part of such an electronic device or accessory. Charging circuitry 613 could alternatively be implemented as part of an adapter or other power source for charging a battery containing electronic device. In any case, charging circuitry 613 can include a switched capacitor converter 612, which can include one or more switched capacitor stages 612a-612c. (Although three switched capacitor stages are depicted, any number of switched capacitor stages could be provided to achieve the desired conversion ratio and/or range of conversion ratios.) Switched capacitor converter 612 can receive input power (Vbus×Ibus) and delivers it at a reduced voltage (Vbus/N) and increased current (Tbus×N) to a buck regulator 614. The number N may be an integer fraction/multiple applied to the input voltage and current and can be determined by the number of switched capacitor stages.

In general, a single switched capacitor stage can provide a 2:1 conversion ratio, a two-stage switched capacitor stage can provide either a 2:1 or 3:1 ratio, etc. Stated more generally, “N−1” switched capacitor stages can provide a conversion ratio between N:1 and 1:1. To provide the highest conversion ratio, each switched capacitor stage can be actively operated alternating between the series and parallel modes described above. To provide lower conversion ratios, one or more switched capacitor stages can be actively operated as described above with one or more switched capacitor stages bypassed to provide a passthrough of the voltage they receive. For example, two “upstream” switched capacitor stages (e.g., 612a, 612b) could be actively operated as described above while one or more “downstream” switched capacitor stages (e.g., 612c) could be in a passthrough mode to provide a 3:1 conversion ratio.

As described above, the reduced voltage/increased current from switched capacitor converter 612 can be delivered to buck regulator 614. Buck regulator 614 can produce an output voltage Vout and output current Iout regulated by a battery charging control loop to be appropriate for the instantaneous battery charging needs. For example, buck regulator 614 can be operated in a constant current mode during an initial battery charging stage and in a constant voltage mode during a later battery charging stage. The target current and/or voltage for battery charging can be determined by one or more control loops monitoring the battery parameters such as voltage, temperature, state of charge, etc. These battery control loops may be implemented in controller circuitry 640 (discussed below) or may be implemented by a separate battery charging controller, with their target values provided to controller circuitry 640. In any case, the output of buck regulator 614 can then be delivered to battery 615 (or to another load bus of the electronic device).

Controller circuitry 640 can implement the required control logic, control loops, and provide the control signals for the switching devices of switched capacitor converter 612, buck regulator 614, and (optionally) the battery charging control loops. Controller circuitry 640 can be implemented as any combination of analog control circuitry, such as comparators and operational amplifiers; digital control circuitry, such as logic gates, state machines, etc.; and/or programmable control circuitry, such as microcontrollers, microprocessors, FPGAs, CPLDs, etc. Such circuitry can be implemented in any combination of discrete components and/or integrated circuits, including application specific integrated circuits (ASICs).

In one aspect, controller circuitry 640 can implement one or more control loops to provide the switching control signals for switched capacitor converter 612, including multiple switched capacitor stages 612a-612c. Such switching control signals may be generated in response to one or more monitored parameters, such as input voltage, input current, output voltage, output current, flying capacitor current, flying capacitor voltage, etc. In one embodiment, the switching frequency of the switched capacitor converter can be regulated based on a comparison of the flying capacitor voltage phase to the mode transitions of the switched capacitor converter to use the resonant operation of the switched capacitor stages to achieve soft switching. However, controller 640 can implement any desired control algorithm or technique to maintain the desired resonant operation.

In another aspect, controller circuitry 640 can implement one or more control loops to provide the switching control signals for buck regulator 614. As noted above, one function of buck regulator 614 can be to provide the instantaneous battery charging current and/or battery charging voltage necessary to achieve a desired battery charging profile. In some cases, such as an initial charging phase, this might include operating buck regulator 614 to achieve a regulated constant output current. In other cases, such as a later charging phase, this might include operating buck regulator 614 to achieve a regulated constant output voltage. The specific current and voltage may be determined by a battery charging control loop or algorithm, which may be implemented by controller circuitry 640 or by other controller circuitry that determines the required control mode (e.g., current control or voltage control) for buck regulator and the target value (e.g., current or voltage), which can then be provided to controller circuitry 640. In any case, controller circuitry 640 can then generate the switch control signals for the buck regulator accordingly. It should be noted that buck regulator need not be configured to operate with the same switching frequency as the switched capacitor converter 612. In other words, buck regulator 614 can be controlled somewhat independently from switched capacitor converter 612. However, in at least some embodiments, the reverse may be true, and the converters can be operated with the same switching frequency.

The foregoing describes exemplary embodiments of high efficiency power converters based on switched capacitor circuits. Such configurations may be used in a variety of applications but may be particularly advantageous when used in conjunction with charging circuits for electronic devices such as notebook or laptop computers, smart phones, tablet computers, and their associated peripherals. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A circuit for high efficiency battery charging, comprising:
a resonant switched capacitor converter that receives an input voltage and input current from a power source and produces an intermediate voltage that is a fraction of the input voltage and an intermediate current that is a corresponding multiple of the input current; and
a buck regulator that receives the intermediate voltage and the intermediate current and produces an output battery charging voltage and an output battery charging current, wherein the output battery charging voltage is less than the intermediate voltage.

2. The circuit of claim 1 wherein the resonant switched capacitor converter comprises one or more resonant switched capacitor stages.

3. The circuit of claim 2 wherein the one or more resonant switched capacitor stages each comprise:
a ladder of four switching devices coupled across an input of the resonant switched capacitor stage;
a resonant tank circuit including a flying capacitor and a resonant inductance coupled between a junction of a first and a second switching device of the ladder and a junction of a third and fourth switching device of the ladder; and
an output terminal located at a junction of the second and third switching devices of the ladder.

4. The circuit of claim 3 wherein the resonant tank circuit is a series resonant circuit.

5. The circuit of claim 3 wherein the resonant inductance includes a discrete inductance.

6. The circuit of claim 3 wherein the resonant inductance consists of one or more parasitic inductances.

7. The circuit of claim 1 further comprising controller circuitry that regulates a switching frequency of the resonant switched capacitor converter to achieve soft switching.

8. The circuit of claim 7 wherein the controller circuitry regulates the switching frequency of the resonant switched capacitor converter to achieve soft switching responsive to a phase of a flying capacitor voltage of the resonant switched capacitor converter relative to mode transitions of the resonant switched capacitor converter.

9. The circuit of claim 7 wherein the controller circuitry controls switching of the buck regulator to produce the output battery charging voltage and output battery charging current responsive to a battery charging profile control loop.

10. The circuit of claim 9 wherein a switching frequency of the buck regulator is independent of a switching frequency of the resonant switched capacitor converter.

11. A power converter, comprising:
a resonant switched capacitor converter having one or more resonant switched capacitor stages, each resonant switched capacitor stage further comprising:
a ladder of four switching devices coupled across an input of the resonant switched capacitor stage;
a resonant tank circuit including a flying capacitor and a resonant inductance coupled between a junction of a first and a second switching device of the ladder and a junction of a third and fourth switching device of the ladder; and
an output terminal located at a junction of the second and third switching devices of the ladder;
wherein the resonant switched capacitor converter receives an input voltage and input current from a power source and produces an intermediate voltage that is a fraction of the input voltage and an intermediate current that is a corresponding multiple of the input current;
a buck regulator that receives the intermediate voltage and the intermediate current and produces an output voltage and an output current, wherein the output voltage is less than the intermediate voltage; and
controller circuitry that regulates a switching frequency of the resonant switched capacitor converter to achieve soft switching.

12. The power converter of claim 11 wherein the resonant tank circuit is a series resonant circuit.

13. The power converter of claim 11 wherein the resonant inductance includes a discrete inductance.

14. The power converter of claim 11 wherein the resonant inductance consists of one or more parasitic inductances.

15. The power converter of claim 11 wherein the controller circuitry regulates the switching frequency of the resonant switched capacitor converter to achieve soft switching responsive to a phase of a flying capacitor voltage of the resonant switched capacitor converter relative to mode transitions of the resonant switched capacitor converter.

16. A resonant switched capacitor converter having one or more resonant switched capacitor stages, each resonant switched capacitor stage comprising:
a ladder of four switching devices coupled across an input of the resonant switched capacitor stage;
a resonant tank circuit including a flying capacitor and a resonant inductance coupled between a junction of a first and a second switching device of the ladder and a junction of a third and fourth switching device of the ladder;
an output terminal located at a junction of the second and third switching devices of the ladder; and
controller circuitry that regulates a switching frequency of the resonant switched capacitor converter to achieve soft switching.

17. The resonant switched capacitor converter of claim 16 wherein the resonant tank circuit is a series resonant circuit.

18. The resonant switched capacitor converter of claim 16 wherein the resonant inductance includes a discrete inductance.

19. The resonant switched capacitor converter of claim 16 wherein the resonant inductance consists of one or more parasitic inductances.

20. The resonant switched capacitor converter of claim 16 wherein the controller circuitry regulates the switching frequency of the resonant switched capacitor converter to achieve soft switching responsive to a phase of a flying capacitor voltage of the resonant switched capacitor converter relative to mode transitions of the resonant switched capacitor converter.
